(19) United States
(12) Patent Application Publication
(10) Pub. No.: US 2025/0131372 A1
(43) Pub. Date: Apr. 24, 2025

(54) STANDARDIZED EVENT HANDLING FOR SENSOR INSTALLATIONS

(71) Applicant: SAP SE, Walldorf (DE)

(72) Inventors: Ulrich Bestfleisch, Speyer (DE); Michael Hildebrand, Mannheim (DE)

(21) Appl. No.: 18/382,908

(22) Filed: Oct. 23, 2023

(51) Int. Cl. G06Q 10/087; G06F 16/23

(52) U.S. Cl. CPC G06Q 10/087; G06F 16/2365

(57) ABSTRACT

Systems and methods described herein relate to an event handling platform for sensor installations. An event message is received from an identified sensor installation. The identified sensor installation is associated with a facility. The event message is indicative of an event detected by the identified sensor installation. The event is validated against a schema of an identified event type from among a plurality of event types by comparing the event message to metadata of the identified event type. The metadata may be stored in an event metadata repository. The event message is transmitted to a software application associated with the facility to trigger an event reaction. Based on the event reaction, status data for the facility is caused to be presented at a user device accessing the software application.

### TECHNICAL FIELD

The subject matter disclosed herein generally relates to sensor installations. More specifically, but not exclusively, the subject matter relates to an event handling platform for events detected by sensor installations.

### BACKGROUND

Various types of facilities can be equipped with “smart” sensors. For example, some retail facilities employ smart technology to improve operations or customer experience. In retail stores, IoT (Internet of Things) sensors can be used to detect and report on various in-store events, allowing a retail store to track product information, inventory levels, cold chain compliance, or foot traffic.

The integration of smart technologies into the business processes of a facility can be technically challenging. For example, in order to deploy a smart technology solution, a retail facility may utilize products from different vendors, each having its own hardware, software, data formats, communication interfaces, or dashboards. The retail facility may then have to develop custom integrations between the product of each vendor and their internal infrastructure, such as the enterprise resource planning system or inventory system of the retail facility. This may result in technical difficulties, such as problems in mapping vendor data formats to internal data formats, as well as inefficient resource utilization (e.g., resulting from duplicated efforts and high deployment costs).

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes an event handling platform, according to some examples.

FIG. 2 diagrammatically illustrates the detection of an event at a facility and the automated handling of the event by an event handling platform, according to some examples.

FIG. 3 is a block diagram of certain components of an event handling platform, according to some examples.

FIG. 4 is a flowchart illustrating operations of a method suitable for validating an event message and routing the event message to a cloud-based application, according to some examples.

FIG. 5 is a user interface diagram illustrating a graphical user interface (GUI) of a task management application in a first state, according to some examples.

FIG. 6 is another user interface diagram illustrating the GUI of the task management application of FIG. 5 in a second state, according to some examples.

FIG. 7 is an interaction diagram illustrating interactions between various components to validate, route, and store the details of an event, according to some examples.

FIG. 8 is a flowchart illustrating operations of a method suitable for providing an event modeling tool and allowing a user to create an event type, according to some examples.

FIG. 9 diagrammatically illustrates different event types in an event metadata repository that are accessible in a first tenant and a second tenant, according to some examples.

FIG. 10 is a block diagram showing a software architecture for a computing device, according to some examples.

FIG. 11 is a block diagram of a machine in the form of a computer system, according to some examples, within which instructions may be executed for causing the machine to perform any one or more of the methodologies discussed herein.

### DETAILED DESCRIPTION

As mentioned, the integration of smart technologies into business processes may present technical challenges. For example, in the context of a retail facility, while the retail facility may have various options when it comes to available smart technologies for use in detecting in-store events (e.g., for detecting product movements or inventory level changes), significant effort, resources, and technical expertise may be needed to link these smart technologies to other systems of the retail facility (e.g., to provide a centralized view across disparate data sources or to ensure that a task management system reacts to events detected by in-store sensors).

For example, the retail facility may procure a shelf monitoring solution that utilizes cameras, weight sensors, radio-frequency identification (RFID) sensors, or other hardware to detect events relating to shelf-displayed products, such as “out-of-shelf” events. However, to leverage the capabilities of the shelf monitoring solution, the retail facility may have to build custom integrations to trigger business processes. For example, the shelf monitoring solution may need to be connected to an existing inventory system to ensure that a restocking process is only triggered if a shelf is empty and there is available stock on hand. The shelf monitoring solution and inventory system may operate based on significantly different rules, data formats, and communication protocols, thus requiring custom integration work.

Where multiple technologies or technology vendors are involved (e.g., different providers that each have their own Application Programming Interface [API]), the custom integration work may have to be repeated. Furthermore, ensuring that event-related data items are stored in a desired format within a central database may also require technology-specific or vendor-specific work. In some cases, the lack of standardization, market fragmentation, or integration difficulties described above may result in owners or operators of facilities (e.g., retail facilities) being hesitant to adopt smart technologies.

Examples described herein provide a sensor-agnostic and technology vendor-agnostic event handling platform that may accommodate multiple different sensor technologies or multiple different facilities. The event handling platform may simplify integration, improve event data integrity, automate workflows, and facilitate the centralized storage of, and access to, event data. By addressing or alleviating these technical issues, the event handling platform may facilitate the adoption of smart technologies (e.g., to drive adoption of smart sensors in a retail environment).

As mentioned, various types of facilities may employ smart sensors, and retail facilities are described in non-limiting examples provided in this disclosure. The term “retail facility,” as used herein, refers to any permanent or temporary facility or establishment involved in the sale or distribution of products to consumers. A retail facility may be a retail store or retail shop that sells directly to consumers, or another facility involved in a retail process or supply chain, such as a warehouse, distribution center, storage facility, preparation facility, or order processing facility. Retail facilities may operate in stand-alone buildings or shared buildings, such as malls, shopping centers, or industrial complexes.

A retail facility that is equipped with one or more sensors, such as IoT sensors, used to detect events, automate monitoring processes, or otherwise improve retail operations or customer experience, may be referred to as a “smart” retail facility. The technologies used by the retail facility may be referred to as “smart” technologies.

The term “sensor,” as used herein in the context of a facility (e.g., a retail facility), refers to a device or system that can monitor or detect real-world events, conditions, or state changes. In some cases, sensors convert physical phenomena into electronic data signals that can be processed by computing systems. A sensor may be referred to as an IoT sensor if it is directly or indirectly connected to a network, such as the Internet, and one or more other devices, allowing sensor data to be accessed or processed remotely. Examples of sensors may include weight sensors, RFID readers, cameras, temperature sensors, accelerometers, motion sensors, noise sensors, or vibration sensors, or systems that combine one or more of the aforementioned components. In some cases, a sensor may be part of a moving device, such as a drone or robotic device.

The term “sensor installation,” as used herein in the context of a facility, refers to an installation or deployment that includes one or more of such sensors. A sensor installation may also include a data collection system responsible for receiving input data from one or more sensors, detecting events based on the input data, or transmitting event messages to other components or systems.

Systems and methods described herein provide an event handling platform for smart facilities, such as smart retail facilities. The event handling platform may be a cloud-based platform that is communicatively coupled to a facility. The event handling platform may be communicatively coupled to the facility by way of a connection with a sensor installation of the facility. For example, a data collection system of the sensor installation may collect data (e.g., receive input data, feedback, or data points) from one or more sensors of the facility. In some examples, the event handling platform may be directly coupled to one or more sensors (e.g., without using a data collection system as an intermediate component).

In some examples, the event handling platform is communicatively coupled to a plurality of sensor installations (and thus, in some examples, to a plurality of facilities). Each of the sensor installations has one or more sensors and may also include a data collection system.

During operation, the event handling platform may receive an event message based on input data from one or more sensors of an identified sensor installation. The sensor installation may be identified based on an identifier of the sensor installation, an identifier of an individual sensor, or an identifier of a facility in or at which the sensor installation is deployed.

For example, the data collection system of the identified sensor installation may detect, based on the input data, an event that occurred in an identified facility. The event message that is sent to the event handling platform is indicative of the event detected by or at the sensor installation. In some examples, the event message is generated in a standardized format to represent an event of a predetermined event type.

The term “event,” as used herein in the context of a facility, refers to an occurrence, incident, state, or state change that is detected using one or more sensors and that relates to the facility (e.g., in the case of a retail store, an event that occurred inside of the retail store). In some examples, an event is directly detected by a sensor (e.g., a weight sensor detects that a shelf is empty). In other examples, an event is detected by a downstream component or system, such as a data collection system of a sensor installation, based on input data from one or more sensors. For example, a spike in foot traffic may be detected by processing input data from multiple sensors in a retail store and comparing the combined input data to a threshold. An event may be represented as a data object, such as an electronic event message, as mentioned above.

In some examples, an event metadata repository contains metadata of each of a plurality of event types associated with one or more facilities. The metadata stored for each event type may define various details of the event type, such as an event name or other event type identifier, a payload associated with the event type, or a schema for event messages that are sent to report events of the event type.

The schema may provide a structured definition and format for reporting of events of the event type. The schema may be a standardized event schema that is used across multiple sensor installations, multiple facilities, multiple users, or multiple tenants, as is described further below. The schema may be vendor-agnostic and technology-agnostic. In some examples, all event types conform to a similar basic schema.

The event handling platform may identify a relevant facility (e.g., the retail facility where an event was detected) based on a facility identifier in the event message or based on an identifier of the sensor installation in the event message. The event handling platform may also identify the event type of the event based on an event type identifier in the event message.

After an event message is received, the event represented by the event message may be validated against the schema of an identified event type by comparing the event message to the metadata of the identified event type. Validation may include determining that the event message conforms to the schema of the identified event type (e.g., has the required data structure and payload).

Validation may include determining that the event message has a standardized payload conforming to the schema of the identified event type as defined by the metadata. In some examples, a technique involves a plurality of sensor installations, each sensor installation associated with a respective facility. The facilities include a first subset of facilities associated with a first tenant and a second subset of facilities associated with a second tenant. The plurality of event types include a plurality of standard event types for which respective metadata are contained in the event metadata repository, and the metadata of each standard event type defines a respective standardized payload for event messages of the standard event type.

In some examples, the event handling platform only routes the event message onward in response to successful validation, and rejects the event message if validation is unsuccessful. The event message may be transmitted to a software application associated with the identified facility (e.g., a retail store associated with the identified sensor installation) to trigger an event reaction. Based on the event reaction, status data for the identified facility may be presented at a user device accessing the software application.

In some examples, after validation, the event message is routed by an event bus. The event bus may perform a first routing operation in which the event message is sent to the software application in real-time (e.g., for real-time consumption). The event bus may also perform a second routing operation to route the event message to a storage component that is accessible via the software application (e.g., for subsequent analytics operations). In some examples, the event bus routes the event message to an event ingestion pipeline that is responsible for a storing operation.

As mentioned, the event handling platform may provide users (e.g., tenants) with access to standard event types. A standard event type may be a generic event type that is predefined and available to all (or multiple) users or tenants of the event handling platform. The event handling platform may further enable users to create user-defined event types. A user-defined event type may be a new event type or an extended version of a standard event type.

In some examples, the event handling platform is communicatively coupled to a plurality of facilities (e.g., via respective sensor installations) that include a first subset of facilities associated with a first tenant and a second subset of facilities associated with a second tenant. The first tenant and the second tenant may thus each have access to the plurality of standard event types, while the first tenant and the second tenant have access to different subsets of the plurality of user-defined event types. For example, the first tenant only has access to the user-defined event types created in the first tenant, and the second tenant only has access to the user-defined event types created in the second tenant. As such, user-defined event types may be tenant-specific in a multi-tenancy cloud architecture.

In some examples, a system provides an event modeling tool to enable creation, addition, or maintenance of event types and their metadata. The event modeling tool may be a software application that provides a GUI to enable users to view, extend, and customize event types. The event modeling tool may access metadata from the event metadata repository (e.g., for additions to existing event types) and store metadata for new event types to the event metadata repository. A method may include causing presentation of a user interface (e.g., a GUI) of the event modeling tool and receiving, via the user interface and from a user of the first tenant, user input to define an additional user-defined event type. The user input may include metadata of the additional user-defined event type. The method may include, in response to receiving the user input, storing the metadata of the additional user-defined event type in the event metadata repository to be accessible to the first tenant and inaccessible to the second tenant. The user input may specify that the additional user-defined event type is a new event type, or that the additional user-defined event type is to be an extended version of a standard event type.

In some examples, event modeling capabilities are exposed as APIs rather than, or in addition to, a GUI. Event modeling APIs may allow programmatic definition and maintenance of event metadata. For example, the APIs provide create, read, update, and delete operations for manipulating event schemas, fields, and other attributes. The event modeling APIs may interact with the event metadata repository to persist newly defined event structures. By leveraging event modeling APIs, event type extensions may be integrated directly into code and workflows may be built to automate at least some aspects of event metadata modifications.

The sensor installation may be installed to monitor or detect events in or near the facility. In some examples, the facility is a retail store, and the sensor installation is used to monitor events that occur in the retail store.

The event reaction triggered by the detection of the event may include automatic adjustment (e.g., by the software application) of a workflow associated with the facility to reflect a task. The status data presented at the user device may include the task (e.g., a new task to be performed in a retail store). Accordingly, the event handling platform may automatically trigger or adjust a business process of the facility based on the detected and routed event.

The software application may be a cloud-based application that subscribes to events of the identified event type. For example, the software application may be a task management application that is accessible via a mobile device. The mobile device may be the user device at which the status data is presented.

Examples described herein provide a standardized framework to address or alleviate the problem of technical interoperability when attempting to integrate sensor data into business processes and analytics systems. In some examples, an event metadata repository containing standardized schemas for events enables technical interoperability between diverse sensor systems, multiple different facilities, and downstream software applications. This may reduce complexity and overhead relating to smart technologies (e.g., smart technologies used in a retail environment).

The validation of events against schemas may provide a technical safeguard to ensure integrity of data flowing into business-critical systems. The extensible nature of the event metadata repository may allow for user-defined event types that are tailored to user needs, while retaining the benefits of the standardized framework of the event handling platform.

In some examples, an event bus of the event handling platform provides real-time and scalable routing of events to destinations. This facilitates the leveraging and analysis of sensor data. For example, the event bus may route events to user-facing software applications to trigger real-time changes in workflows and tasks, while also ensuring that event data are stored for analytics or insight-generation purposes. The event handling platform may automatically process or transform data from various sensor sources into a standardized storage format to enable downstream analysis.

By providing a standardized, extensible, and scalable end-to-end technical architecture for ingesting, routing, responding to, and leveraging sensor data relating to events, examples described herein may provide a practical solution to real-world problems that hinder the integration or adoption of the smart technologies (e.g., in a retail environment). When the effects in this disclosure are considered in aggregate, one or more of the methodologies described herein may obviate a need for certain efforts or resources that otherwise would be involved in smart technology deployment or integration. Computing resources utilized by systems, databases, or networks may be more efficiently utilized or reduced, e.g., as a result of reduced custom integration steps or a reduced number of integration components. Examples of such computing resources may include processor cycles, network traffic, memory usage, graphics processing unit (GPU) resources, data storage capacity, power consumption, and cooling capacity.

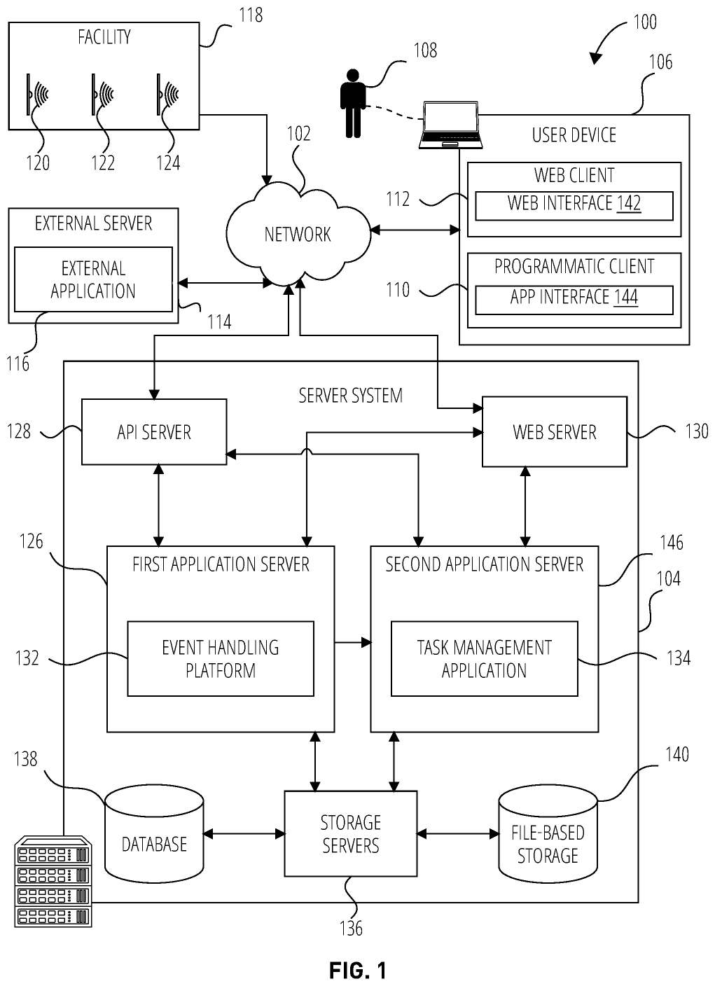

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. The user 108 may be associated with a facility 118 (e.g., a retail store). A web client 112 (e.g., a browser) or a programmatic client 110 (e.g., an “app”) may be hosted and executed on the user device 106.

An API server 128 and a web server 130 provide respective programmatic and web interfaces to components of the server system 104. A first application server 126 hosts an event handling platform 132, which includes components, modules, or applications. A second application server 146 hosts a task management application 134. The event handling platform 132 and the task management application 134 may communicate with each other via a suitable communication component, such as an event bus, as described in greater detail below.

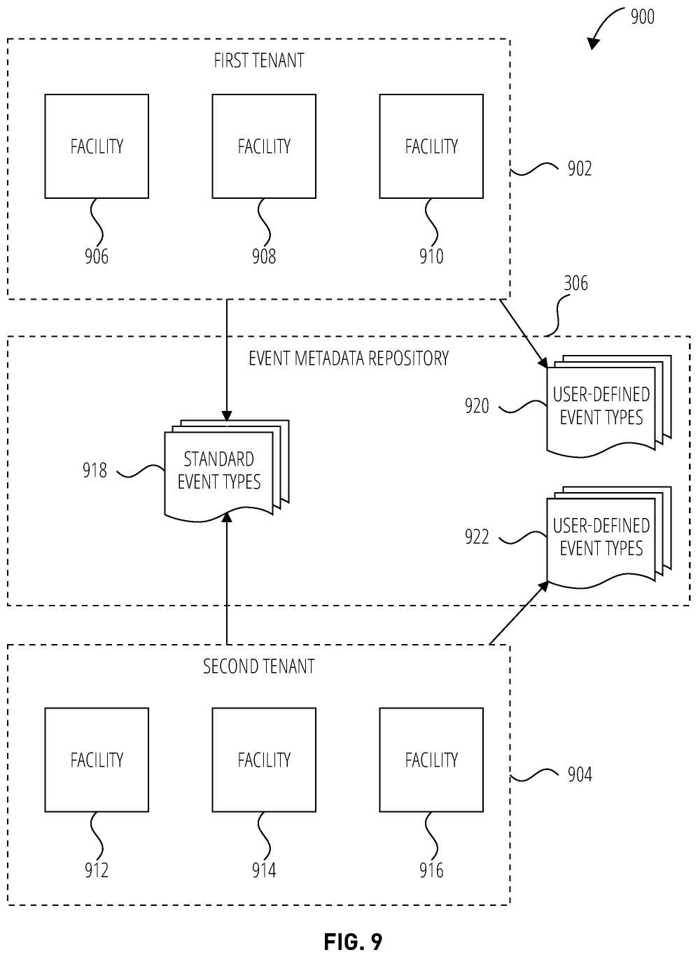

The user device 106 can communicate with the first application server 126 and the second application server 146, e.g., via the web interface supported by the web server 130 or via the programmatic interface provided by the API server 128. It will be appreciated that, although only a single user device 106 is shown in FIG. 1, a plurality of user devices may be communicatively coupled to the server system 104 in some examples. Similarly, although only a single facility 118 is shown in FIG. 1, a plurality of facilities may be communicatively coupled to the server system 104 in some examples. FIG. 9, which is described below, provides a non-limiting example that includes a plurality of facilities associated with different tenants that may be coupled to a server system such as the server system 104 of FIG. 1. Further, while certain functions may be described herein as being performed at either the user device 106 (e.g., web client 112 or programmatic client 110) or the server system 104, the location of certain functionality either within the user device 106 or the server system 104 may be a design choice.

The first application server 126 and the second application server 146 are communicatively coupled to storage servers 136, facilitating access to one or more information storage repositories, e.g., a database 138 and a file-based storage 140, as shown in FIG. 1. In some examples, the database 138 or the file-based storage 140 includes storage devices that store information to be processed by the event handling platform 132 or the task management application 134, e.g., records of sensor data, events detected at the facility 118, or event type metadata.

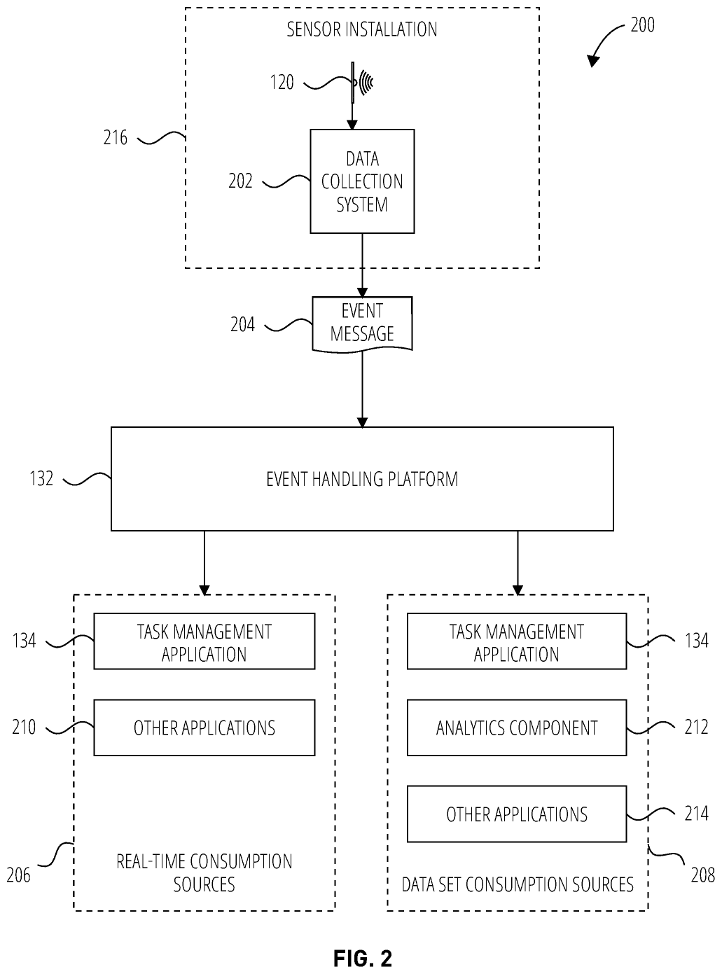

The first application server 126 and the second application server 146 each accesses application data (e.g., application data stored by the storage servers 136) to provide one or more applications or software tools to the user device 106 via a web interface 142 or an app interface 144. As described further below according to examples and with specific reference to FIGS. 2-9, the event handling platform 132 may provide functionality for handling events detected using sensors of the facility 118 (e.g., the sensors 120, 122, 124), triggering event reactions at the task management application 134 based on the detected events, and creating new event types to be handled by the event handling platform 132. The facility 118 may thus be referred to as a smart facility. In examples where the facility 118 is a retail facility, it may be referred to as a smart retail facility.

The event handling platform 132 is configured to receive event messages from one or multiple facilities, such as the facility 118. The event handling platform 132 is responsible for validating events and routing them to destinations, such as subscriber applications. In some examples, the task management application 134 is such a subscriber application.

For example, the task management application 134 may be a cloud-based software application that leverages the event handling platform 132 to manage operations and tasks for a retail store location (as an example of the facility 118) that has a sensor installation. The task management application 134 may consume real-time events from the event handling platform 132 to maintain and update status data and respond to incidents at the store.

For instance, the task management application 134 may receive an “out-of-shelf” event indicating a particular product is no longer in stock on the sales floor. Based on predefined rules and current inventory levels, the task management application 134 automatically creates restocking tasks for store personnel and updates inventory records. The tasks may be transmitted to a store staff device (e.g., the user device 106 executing the programmatic client 110) along with other notifications and dashboard updates provided by the task management application 134.

The event handling platform 132 may also be configured to store event data for subsequent consumption or analysis (e.g., in a data lake or data warehouse provided by the file-based storage 140). The task management application 134 may then analyze historical event data to generate reports and insights for improving operations (such as retail store operations).

In some examples, the first application server 126 and the second application server 146 are part of a cloud-based platform provided by a software provider that allows the user 108 (and, in some examples, other users) to utilize the features of the event handling platform 132 or the task management application 134. The user 108 may thus be a customer or client of the software provider (or an employee or agent of such a customer or client) that holds a user account with the software provider. In some examples, the event handling platform 132 and the task management application 134 are provided to the user 108 based on a software as a service model. The user 108 may be associated with a specific tenant of a plurality of tenants supported by the software provider.

To access the event handling platform 132 or the task management application 134, the user 108 may create an account (or access an existing account) with an entity associated with the server system 104, such as the software provider. The user 108 may use account credentials to access the web interface 142 and request access to the event handling platform 132 or the task management application 134 (e.g., as a user of a specific tenant). The event handling platform 132 or the task management application 134 may automatically create a service instance associated with the event handling platform 132 or the task management application 134 at the first application server 126 or the second application server 146, respectively, which can be accessed by the user 108 via one or more service APIs to utilize functionality described herein. The user 108 may also, in some examples, access the event handling platform 132 or the task management application 134 using the programmatic client 110, in which case some functionality may be provided client-side and other functionality may be provided server-side.

The server system 104 may thus be operated or managed by the software provider. Multiple users, each having a user account, may utilize the event handling platform 132 and access instances of software applications, such as the task management application 134, as provided by the software provider. Further, multiple tenants, each having one or more user accounts, may utilize the event handling platform 132. Each tenant may have one or multiple applications connected to the event handling platform 132 (e.g., the task management application 134 may be an application of one specific tenant that is not accessible to other tenants). In some examples, the event handling platform 132 allows for events to be standardized by defining standardized payloads for respective event types that are used across different tenants and sensor installations (which may be provided by different vendors).

It is noted that the task management application 134 demonstrates a non-limiting example of an application that can leverage the features of the event handling platform 132. Various types of software applications, such as inventory management applications, ordering applications, shift management applications, or business process/workflow applications may be connected to the event handling platform 132. The event handling platform 132 may thus, in some examples, have multiple subscriber applications to which events are routed.

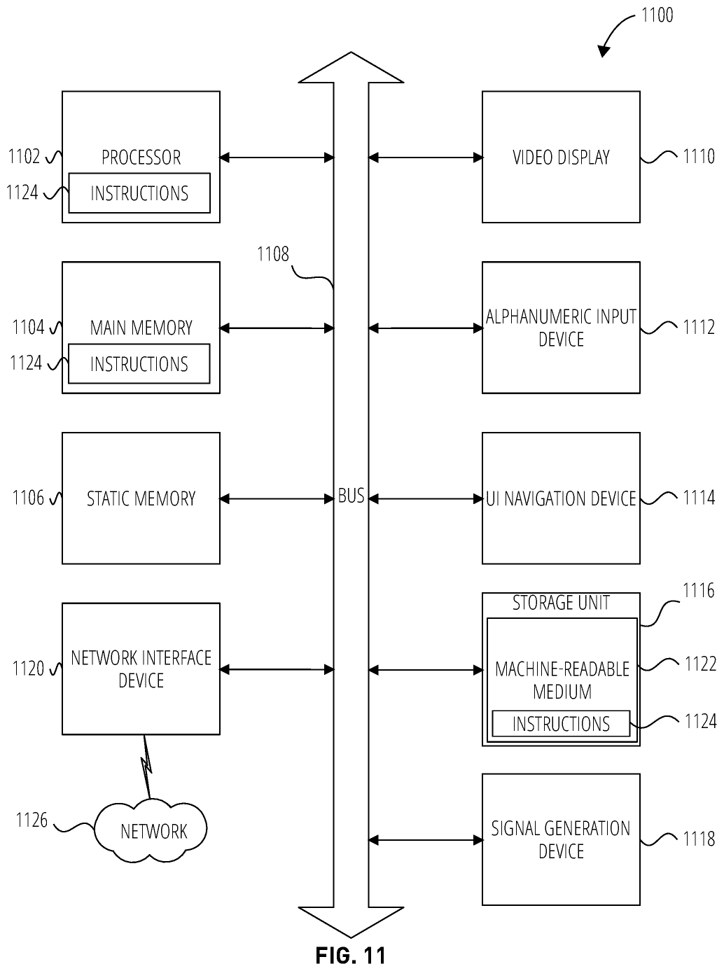

One or more of the first application server 126, the second application server 146, the storage servers 136, the API server 128, the web server 130, the event handling platform 132, or the task management application 134 may each be implemented in a computer system, in whole or in part, as described below with respect to FIG. 11. In some examples, external applications (which may be third-party applications or applications provided by the software provider of the server system 104), such as an external application 116 executing on an external server 114, can communicate with the first application server 126 or the second application server 146 via the programmatic interface provided by the API server 128. For example, a third-party application may support one or more features or functions on a website or platform hosted by a third party, or may perform certain methodologies and provide input or output information to the first application server 126 or the second application server 146 for further processing or publication.

For instance, the external application 116 may collect data from a sensor installation that includes the sensors 120, 122, 124 of the facility 118 and report events to the event handling platform 132 by transmitting suitable event messages. The external application 116 may be associated with a data collection system, such as the data collection system 202 described with reference to FIG. 2.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

FIG. 2 shows a diagram 200 that illustrates the detection of an event and the handling of the event by a cloud-based event handling platform, according to some examples. By way of example and not limitation, some of the components shown in FIG. 1 are again shown in FIG. 2 and further described below.

In the diagram 200, the sensor 120 of the facility 118 of FIG. 1 sends input data to a data collection system 202. The sensor 120 and the data collection system 202 form part of a sensor installation 216 at, in, or otherwise associated with the facility 118.

The data collection system 202 then publishes an event message 204 based on the input data. The event message 204 represents the detected event and is transmitted from the sensor installation 216 to the event handling platform 132 of FIG. 1.

The sensor 120 may be a sensor installed in a retail store for collecting data about store conditions, inventory, shopper behavior, or other events or state changes. The sensor 120 may automatically monitor its surroundings or conditions and convert detected events or conditions into electronic data for transmission. The sensor 120 may, for example, be a computer vision distance sensor, weight sensor, or camera.

The data collection system 202 collects input data from the sensor 120. The data collection system 202 may include hardware, such as an edge computing device with wired or wireless connectivity to the sensors 120. In some examples, the data collection system 202 is provided by a sensor technology system of a third-party (e.g., a vendor of the retailer associated with the facility 118). For example, the data collection system 202 may be a smart technology system provided by a vendor that allows the facility 118 to operate as a smart retail facility.

The data collection system 202 may aggregate and pre-process sensor data from various sources (e.g., the sensors 120, 122, 124) before transmitting event messages to the event handling platform 132 (e.g., via the network 102 of FIG. 1). For example, the data collection system 202 may check whether input data from the sensor 120 includes or qualifies as an “event” to be reported to the event handling platform 132. The data collection system 202 may process a stream of sensor data and publish event messages in response to detecting predetermined events.

In some examples, the sensor 120 itself may generate an event message in a predetermined format, in which case the data collection system 202 may merely pass the event message on to the event handling platform 132 or be bypassed entirely. In other examples, the data collection system 202 may generate the event message. The sensor installation 216 (e.g., the sensor 120 or the data collection system 202 thereof) may thus include a suitable device that is wirelessly connected to the event handling platform 132 for transmitting the event message.

The event message 204 may be an electronic data packet or structure transmitted from the data collection system 202 to the event handling platform 132. As described in greater detail elsewhere, the event message 204 may conform to a standardized data format and contains a payload with details about the specific event (e.g., “product A running low in shelf B”).

The event handling platform 132 receives the event message 204 (e.g., as a JSON (JavaScript Object Notation) object via an API) and routes the event message 204 to one or more real-time consumption sources 206 and one or more data set consumption sources 208. In some examples, the event handling platform 132 forwards (or otherwise provides access to) the event message 204 to the task management application 134 substantially in real-time. This may allow the task management application 134 to trigger an event reaction, such as automatic adjustment of a workflow associated with the facility 118 of the sensor 120. The workflow may be updated to reflect a task, such as a new task to be performed by a store worker in response to the event. The event reaction may thus include or cause updating of status data presented to a user, such as a list of tasks, an inventory status, a stock level, or an event-driven alert.

As mentioned, the task management application 134 may be a cloud-based application that subscribes to events, such as events that have an event type matching that of the event message 204. The user 108 may use a mobile device to access the task management application 134 (e.g., to view and manage tasks).

In addition to the task management application 134, one or more other applications 210 may consume the event message 204, or data relating to the event, in real time. For example, in addition to the task management application 134, the facility 118 may also have a demand management application or a stock ordering application that receives and responds to the event message 204.

The task management application 134, an analytics component 212, and one or more other applications 214 may also access the event message 204, or data relating thereto, at a later stage. For example, the data set consumption sources 208 shown in FIG. 2 may consume or analyze the event message 204 together with other historic event messages as a larger data set. To this end, the event handling platform 132 causes the event message 204 to be stored in a storage location, such as a storage location provided by the file-based storage 140 of FIG. 1.

The analytics component 212 shown in FIG. 2 may be an automated component that, for example, performs statistical analysis, machine learning, or other techniques to extract insights or trends from the stored event data. The analytics component 212 may be part of the task management application 134 or a separate application. The analytics component 212 may be hosted by the server system 104 of FIG. 1 (e.g., as another service provided by the software provider).

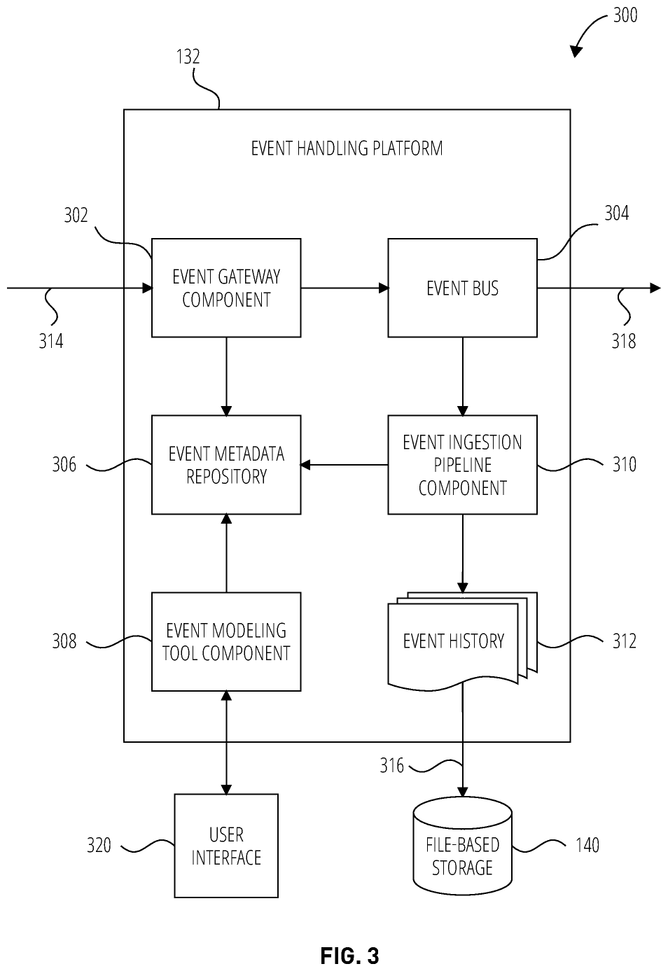

FIG. 3 shows a diagram 300 that illustrates certain components of the event handling platform 132, according to some examples. The event handling platform 132 is shown to include an event gateway component 302, an event bus 304, an event metadata repository 306, an event ingestion pipeline component 310, and an event modeling tool component 308. FIG. 3 further shows event history 312 which is stored in the file-based storage 140 of FIG. 1 (as shown by arrow 316). Further, FIG. 3 shows an incoming event message and an outgoing event message, as illustrated by arrow 314 and arrow 318, respectively, as well as a user interface 320.

The event gateway component 302 provides an interface where the event handling platform 132 receives incoming event messages 204 originating from a sensor installation (e.g., from the data collection system 202 or directly from a sensor). The arrow 314 in FIG. 3 illustrates receipt of an incoming event message.

The event gateway component 302 may include hardware, such as load balancers and servers, for handling event intake. The event gateway component 302 is configured to validate events against metadata from the event metadata repository 306 before passing them to other components of the event handling platform 132.

In some examples, the event bus 304 routes or provides access to validated events within the event handling platform 132 to subscribed applications or storage components. The arrow 318 in FIG. 3 illustrates routing of an event message for real-time consumption (e.g., to the real-time consumption sources 206 of FIG. 2).

The event bus 304 provides a standardized architecture for publishing and distributing events in real-time to many destinations in a scalable manner. The event bus 304 may be implemented using message broker or streaming technologies. An example of a message broker that may be used to implement the event bus 304 is RabbitMQ™. RabbitMQ™ is an open source message broker based on a publish/subscribe model. An example of a streaming platform that allows applications to publish and subscribe to events is Apache Kafka™.

The event metadata repository 306 stores metadata of each of a plurality of event types. The event metadata repository 306 may store schemas, formats, or definitions for various event types supported by the event handling platform 132. The event metadata repository 306 provides the metadata that the event gateway component 302 uses to validate incoming event messages 204. The event metadata repository 306 may contain reusable event type definitions to facilitate extending standard events or adding new events, as described further below. The event metadata repository 306 may be stored in a storage component, such as the database 138 of FIG. 1.

In some examples, each event type supported by the event handling platform 132 has a defined schema. The schema may provide a structured definition and format for reporting of events of the event type. The schema may be a standardized event schema that is used across multiple facilities (e.g., multiple retail facilities), sensor installations, or tenants. For example, certain event types may be standardized across multiple facilities, sensor installations, or tenants. In some examples, all event types conform to a similar basic schema.

The schema may explicitly define the required fields, data types, or values that should be present in an event message for it to be valid. Standardized event schemas enable interoperability by ensuring events shared between systems (e.g., different sensors or different retailer systems) adhere to the same specifications. They allow events from disparate sources to be commonly understood and processed without custom translation or integration components.

In some examples, one or more of the following metadata items may be present for an event type defined in the event metadata repository 306:
Event type identifier: A unique name or other identifier for the event type. In some examples, the event type identifier follows a standard naming convention.
Event type description: a human-readable description of what the event represents.
Technical format: for example, a JSON format or XML (Extensible Markup Language) format may be used.
Event frequency: an indication of how often the event is expected to be emitted.
Event payload: a description of the data fields that will be contained in an event instance payload. For example, the payload may include a store identifier, a product identifier, location details, measurement details, or combinations thereof.
Event owner: contact information for the team responsible for the event definition.
Tags/taxonomy: categorization data, such as tags, to indicate the domain or functionality.
Event history: whether the event should be ingested into the event history.
Technical system information: technical details, such as protocol, required security roles, or API specification.

Version history: a history that is used to track changes to the event type over time.

The metadata may thus define a schema for the structure and data types of the event (e.g., the payload). In some examples, both the metadata for each event type and the event messages conform to standardized formats. For example, the metadata for each event type may have a technical format that conforms to the AsyncAPI™ standard, and (valid) event messages may conform to the CloudEvents™ standard. The AsyncAPI™ standard allows for the creation of event schemas or formats in a standardized format and can be used to create machine-readable definitions of events, payloads, or protocols. The CloudEvents™ standard provides a specification for describing event data in a common format (e.g., using a common envelope with fields such as “ID,” “source,” “type,” and “specversion”).

As an example, in a retail facility context, one of the event types supported by the event handling platform 132 may be an “out-of-shelf” event type. The event message for an event (instance) of this event type may include the payload as shown below, and may be based on a schema such as the one provided thereafter. This event type may be a standard event type that is used across a plurality of facilities, tenants, or sensor installations.

“Out-of-shelf” example:

```
Event:
{
  “id”: “a00b7888-42d0-4e26-8579”,
  “specversion”: “1.0”,
  “type”: “retail.store.Product.OutOfShelf.v0”,
  “source”: “/default/source.io”,
  “subject”: “81206549”,
  “time”: “2024-07-01T12:26:51.362Z”,
  “datacontenttype”: “application/json”,
  “data”: {
    “storeId”: “10000”,
    “productId”: “812065492437”,
    “placement”: {
        “floor”: “1st”,
        “aisle”: 5,
        “shelf”: 2,
      “planogramPosition”: {
          “sequenceNumber”: 2,
              “level”: 4
        }
    }
  }
}
Event schema:
{
  “$schema”: “http://json-schema.org/draft-07/schema#”,
  “type”: “object”,
  “additionalProperties”: false,
  “properties”: {
    “storeId”: {
        “$schema”: “http://json-schema.org/draft-07/schema#”,
        “type”: “string”,
        “minLength”: 1,
        “maxLength”: 100,
        “examples”: [
            “1000”,
            “2000”
        ],
        “description”: “Identifier of a store”
    },
    “productId”: {
        “$schema”: “http://json-schema.org/draft-07/ schema#”,
        “type”: “string”,
        “minLength”: 1,
        “maxLength”: 100,
        “examples”: [
            “HT-5000”,
            “12171217”
        ],
        “description”: “Identifier of a product”
    },
    “placement”: {
        “$schema”: “http://json-schema.org/draft-07/schema#”,
        “type”: “object”,
        “additionalProperties”: false,
        “properties”: {
            “shelf”: {
              “type”: “integer”,
              “maximum”: 9999999999,
              “example”: [
                2,
                12
              ],
              “description”: “Identifier of a shelf”
            },
            “planogramPosition”: {
              “type”: “object”,
              “properties”: {
                “sequenceNumber”: {
                  “type”: “integer”,
                  “maximum”: 9999999999,
                  “examples”: [
                    3
                  ],
                  “description”: “Sequential number of a product
on a level in a planogram (if defined) or within the complete
planogram (if level is omitted)”
                },
                “level”: {
                  “type”: “integer”,
                  “maximum”: 9999999999,
                  “examples”: [
                    4
                  ],
                  “description”: “Vertical position within a
shelf”
                }
              },
              “required”: [
                “sequenceNumber”
              ],
              “additionalProperties”: false
            },
            “floor”: {
              “type”: “string”,
              “description”: “Floor on which the shelf is
located”,
              “minLength”: 1,
              “maxLength”: 100,
              “examples”: [
                “1st”,
                “2nd”
              ]
            },
            “aisle”: {
              “type”: “integer”,
              “description”: “Aisle in which the shelf is
located”,
              “maximum”: 9999999999,
              “examples”: [
                4
              ]
            }
        },
        “required”: [
            “shelf”
        ]
    }
  },
  “required”: [
    “storeId”,
    “productId”,
    “placement”
  ]
}
```

In the above example, the event type identifier is “retail. store. Product. OutOfShelf.v0.” As another example, a further one of the event types supported by the event handling platform 132 may be a “shelf restocked” event type. The event message for an event (instance) of this event type may include the payload as shown below, and may be based on a schema such as the one provided thereafter. This event type may be a standard event type that is used across a plurality of facilities, tenants, or sensor installations.

“Shelf restocked” example:

```
Event:
{
  “id”: “a00b7888-42d0-4e26-8579”,
  “specversion”: “1.0”,
  “type”: “retail.store.Product.ShelfRestocked.v0”,
  “source”: “/default/source.io”,
  “subject”: “81206549”,
  “time”: “2024-07-01T13:15:51.362Z”,
  “datacontenttype”: “application/json”,
  “data”: {
    “storeId”: “10000”,
    “productId”: “812065492437”,
    “placement”: {
      “shelf”: 2
    }
  }
}
Event schema:
{
  “$schema”: “http://json-schema.org/draft-07/schema#”,
  “type”: “object”,
  “additionalProperties”: false,
  “properties”: {
    “storeId”: {
      “$schema”: “http://json-schema.org/draft-07/schema#”,
      “type”: “string”,
      “minLength”: 1,
      “maxLength”: 100,
      “examples”: [
        “1000”,
        “2000”
      ],
      “description”: “Identifier of a store”
    },
    “productId”: {
      “$schema”: “http://json-schema.org/draft-07/schema#”,
      “type”: “string”,
      “minLength”: 1,
      “maxLength”: 100,
      “examples”: [
        “HT-5000”,
        “12171217”
      ],
      “description”: “Identifier of a product”
    },
    “placement”: {
      “$schema”: “http://json-schema.org/draft-07/schema#”,
      “type”: “object”,
      “additionalProperties”: false,
      “properties”: {
        “shelf”: {
          “type”: “integer”,
          “maximum”: 9999999999,
          “example”: [
            2,
            12
          ],
          “description”: “Identifier of a shelf”
        },
        “planogramPosition”: {
          “type”: “object”,
          “properties”: {
            “sequenceNumber”: {
              “type”: “integer”,
              “maximum”: 9999999999,
              “examples”: [
                3
              ],
              “description”: “Sequential number of a product
on a level in a planogram (if defined) or within the complete
planogram (if level is omitted)”
            },
            “level”: {
              “type”: “integer”,
              “maximum”: 9999999999,
              “examples”: [
                4
              ],
              “description”: “Vertical position within a
shelf”
            }
          },
          “required”: [
            “sequenceNumber”
          ],
          “additionalProperties”: false
        },
        “floor”: {
          “type”: “string”,
          “description”: “Floor on which the shelf is
located”,
          “minLength”: 1,
          “maxLength”: 100,
          “examples”: [
            “1st”,
            “2nd”
          ]
        },
        “aisle”: {
          “type”: “integer”,
          “description”: “Aisle in which the shelf is
located”,
          “maximum”: 9999999999,
          “examples”: [
            4
          ]
        }
      },
      “required”: [
        “shelf”
      ]
    },
    “stockQuantity”: {
      “type”: “object”,
      “description”: “Stock on shelf after restocking”,
      “properties”: {
        “level”: {
          “type”: “string”,
          “description”: “Qualitative stock level”,
          “examples”: [
            “SUFFICIENT”
          ],
          “enum”: [
            “NONE”,
            “TOOLOW”,
            “SUFFICIENT”
            “MAXIMUM”
          ]
        },
        “unit”: {
          “type”: “string”,
          “maxLength”: 5,
          “description”: “Unit”,
          “examples”: [
            “EA”
          ]
        },
        “quantity”: {
          “type”: “string”,
          “format”: “decimal”,
          “description”: “Absolute quantity (in units) in
shelf”,
          “examples”: [
            “3”
          ]
        },
        “quantityRange”: {
          “type”: “object”,
          “description”: “Range of quantity on in shelf”,
          “properties”: {
            “lower”: {
              “type”: “string”,
              “format”: “decimal”,
              “description”: “Lower end of the quantity range
  (inclusive)”,
              “examples”: [
                “2”
              ]
            },
            “upper”: {
              “type”: “string”,
              “format”: “decimal”,
              “description”: “Upper end of the quantity range
  (inclusive)”,
              “examples”: [
                “4”
              ]
            }
          },
          “required”: [
            “lower”,
            “upper”
          ],
          “additionalProperties”: false
        }
      },
      “additionalProperties”: false
    }
  },
  “required”: [
    “storeId”,
    “productId”,
    “placement”
  ]
}
```

In the above example, the event type identifier is “retail.store.Product. ShelfRestocked.v0.” In both examples, the event message is a JSON object that represents the structure of the event. The fields follow the CloudEvents™ specification for an envelope, and the “data” field contains event-specific payload information. Additional examples of event types and event messages are provided below.

It is noted that, in the examples above, the event message has a standard format of “ID,” “specversion,” “type,” “source,” “subject,” “time,” “datacontenttype,” and “data.” For each new incoming event, the event gateway component 302 may check this format to determine whether the event message conforms to a standard format or schema in order to validate the event. This may be applied across different sensor installations or facilities (e.g., across all or multiple different retailers using the event handling platform 132) and across different types of sensor technology.

The event metadata repository 306 may be implemented as a layered repository in which a software provider makes a plurality of standard event types available to its users in a base layer, and in which users are then enabled to extend those standard event types or create new event types in a user layer (or tenant layer). The event modeling tool component 308 provides the user interface 320 for defining new event types or extending existing event type definitions. The user interface 320 may, for example, be accessed via the user device 106 of FIG. 1.

The event modeling tool component 308 communicates with the event metadata repository 306 to fetch metadata and to store new, extended, or modified metadata. The event modeling tool component 308 allows the event handling platform 132 to be customized (e.g., for a specific user instance) by creating user-defined event types (e.g., in the user layer referred to above). As described above, user-defined event types may also be created or extended using APIs.

Referring now to the event ingestion pipeline component 310, once events are published to event bus 304, the event ingestion pipeline component 310 subscribes to and consumes them as shown in FIG. 3. The event ingestion pipeline component 310 communicates with the event metadata repository 306 to obtain additional metadata about an event message, and may transform an event message into a desired format to create the event history 312. The arrow 316 in FIG. 3 illustrates that the event history 312 may be persisted to the file-based storage 140 for long term access.

The event ingestion pipeline component 310 may be implemented using batch or streaming data processing technologies. For example, the event ingestion pipeline component 310 may be implemented as a streaming job using Spark Streaming™, with event history being persisted in Apache Parquet™ files (as an example of a columnar data storage format) in storage, such as Amazon S3™ or Azure Blob Storage™. The event history 312 may be stored in a data lake to facilitate subsequent analytics operations (e.g., by the analytics component 212 of FIG. 2). For example, the event history 312 may be arranged by event type in the file-based storage 140.

In some examples, at least some of the components shown in FIG. 2 or FIG. 3 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

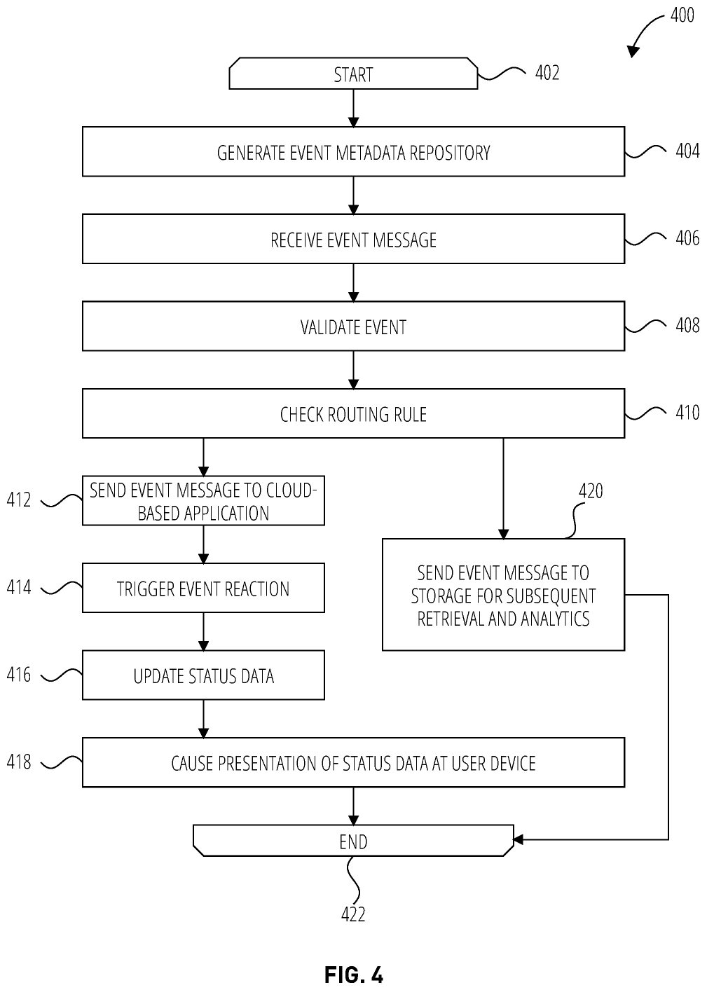

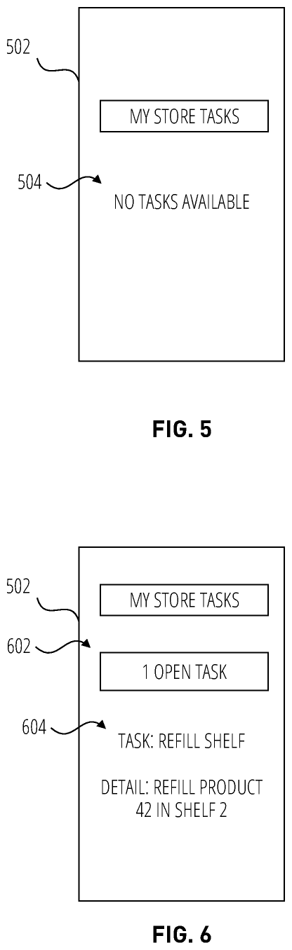

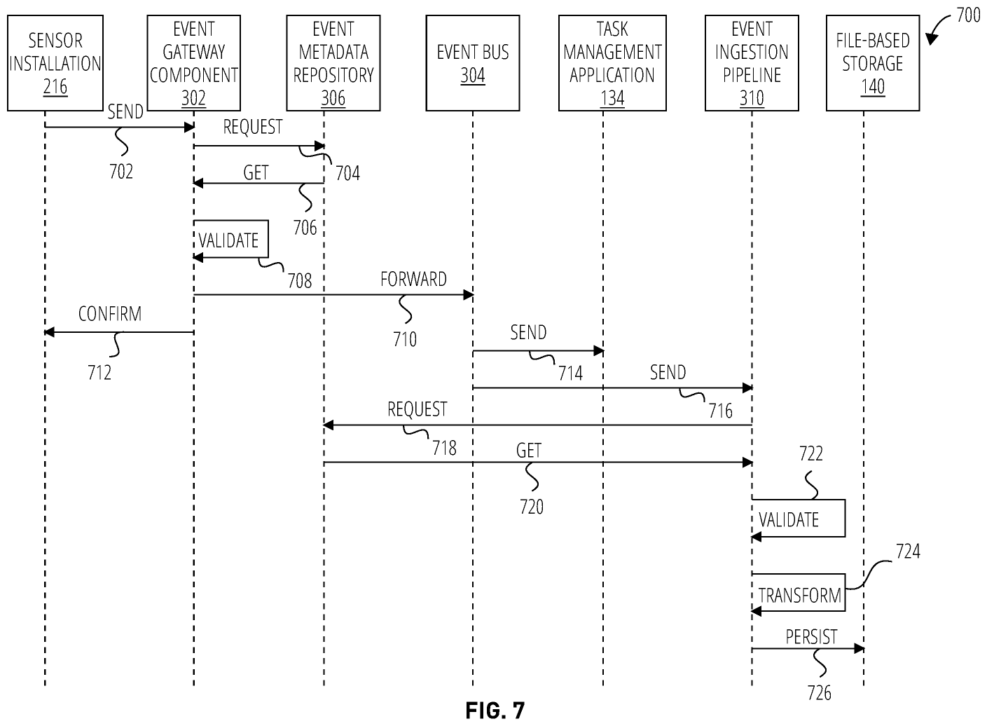

FIG. 4 is a flowchart illustrating operations of a method 400 suitable for validating an event and routing the event to a cloud-based application, according to some examples. By way of example and not limitation, aspects of the method 400 may be performed by the components, devices, systems, or networks shown in FIGS. 1-3. Furthermore, by way of example and not limitation, reference is made to elements shown in FIGS. 5 and 6 to illustrate certain aspects of the method 400.

The method 400 commences at opening loop element 402 and proceeds to operation 404, wherein the event handling platform 132 generates the event metadata repository 306. For example, the event metadata repository 306 may be created and populated to include metadata for each of a plurality of event types relevant to the facility 118 of FIG. 1. The facility 118 may utilize standard event types or user-defined event types, or both (see FIG. 9). The event metadata repository 306 may be periodically modified or updated, as described elsewhere. The event metadata repository 306 may define, in a standardized manner, event types used across multiple facilities or sensor installations (e.g., relating to different tenants).

At operation 406, the event gateway component 302 of the event handling platform 132 receives a new event message originating from the sensor installation. The event message may be generated by a sensor (e.g., the sensor 120) or by a downstream system (e.g., the data collection system 202) based on input data from one or more sensors.

The event gateway component 302 determines the event type of the event represented by the event message (e.g., by checking its event type identifier) and then validates the event (operation 408). For example, the event message may be checked against the schema defined in the event metadata repository 306 for the specific event type. This may involve checking the format, structure, or data fields of the event message (or combinations thereof).

The event gateway component 302 may identify one or both of the sensor installation or its associated facility. The event gateway component 302 may identify the facility in which the sensor installation is deployed by checking a facility identifier in the event message or may identify the sensor installation by checking a sensor identifier in the event message (e.g., an identifier of the sensor installation or an individual sensor thereof).

If the event message conforms to the schema, it is deemed to be valid. If it does not conform to the schema, the event gateway component 302 may reject the event message. For example, the event gateway component 302 may transmit a rejection notification to the facility 118 (e.g., to its data collection system 202) instead of passing the event message on to the event bus 304. In this way, the event handling platform 132 ensures a standardized format that can, for example, be used across different retailers and sensor technologies, while also ensuring data integrity in downstream components.

After the event message has been validated by the event gateway component 302, the event handling platform 132 then causes the event message to be routed to one or more destinations. The event bus 304 may check a routing rule at operation 410. For example, the event bus 304 may determine that the event message should be made available to one or more subscribing applications and stored in a storage location.

In the method 400, the event message is then sent to a cloud-based application (operation 412) based on a subscription rule. The cloud-based application may be the task management application 134 of FIG. 1. The routing of the event message may be referred to as a first routing operation that allows for real-time consumption of the event. Additionally, operation 420 is performed and the event message is sent to storage for subsequent retrieval and analytics.

Receipt of the event message at the cloud-based application may trigger an event reaction at operation 414. Referring again to the shelf restocking examples, the event message may indicate that a shelf in the facility 118 has been depleted, and the event message may trigger adjustment of an automated workflow by the cloud-based application to indicate that restocking is needed. This may in turn cause updating of status data at operation 416 and presentation of the status data at a user device at operation 418, as described with reference to examples below. The method 400 concludes at closing loop element 422.

FIGS. 5 and 6 are user interface diagrams illustrating an example GUI 502 which may be presented on a user device, such as the user device 106 of FIG. 1. The GUI 502 may be provided by the task management application 134 (e.g., a task management application for a retail store). For example, prior to the event message triggering the event reaction at operation 414, the GUI 502 of FIG. 5 may be presented to a user working at the facility 118. In FIG. 5, the GUI 502 presents status data 504 indicating that no tasks are available.

The event message may, for example, be an “out-of-shelf” event message as shown above. This event message triggers a new task, as shown in FIG. 6. The GUI 502 is shown in an updated state in FIG. 6, in which updated status data 602 indicates an open task 604 (“REFILL SHELF”). The event reaction that is triggered is therefore linked to the event type of the incoming event.

For example, the task management application 134 may automatically check an inventory database of the facility 118 and, if there is enough stock, create the new task in the task management application 134. Once the shelf has been restocked, the event handling platform 132 may receive a further event message of the “shelf restocked” type. The further event message may trigger an event reaction that automatically updates a workflow of the facility 118 to remove the open task 604 (e.g., reverting the GUI 502 back to the state shown in FIG. 5). In this way, the sensor technology used in the facility 118 may be easily integrated into other business systems, such as inventory systems and task management workflows, with statuses being updated automatically. This may provide an end-to-end solution for smart technology integration and use.

Referring back to FIG. 4, at operation 420, the event bus 304 performs a second routing operation to route the event message to a storage component that is accessible via the cloud-based application. For example, as described above, the event message may be stored as part of the event history 312 in the file-based storage 140.

The event history 312 may enable various analytical use cases. For example, in the retail context, the task management application 134 may use the event history 312 to calculate shelf availability of products over time by analyzing trends in the “out-of-shelf” and “shelf restocked” event histories to determine durations that a product was missing from its assigned shelf location.

The event history 312 may also be used for demand forecasting purposes. The event history 312 may analyze past demand alongside event messages, such as product stock-outs on shelves, to provide insights. For example, if sales were low due to inadequate shelf inventory, it may indicate consumer demand exceeded available supply. Incorporating event context may allow for more accurate forecasts to be generated, even when past sales were limited by extrinsic factors, such as shelf stock-outs.

The “out-of-shelf” and “shelf restocked” event types were described below to provide examples of the manner in which the event handling platform 132 may be used. Three additional examples of event types and instances of their events are provided below (in each case represented by a JSON object). The additional examples may, in some cases, each be a standard event type that is used across a plurality of facilities, tenants, or sensor installations.

“Crowded area” example—a crowded area near a pay point (“till”) has been detected by a sensor installation in a facility:

```
Event:
{
  “id”: “a00b7888-42d0-4e26-8579-4”,
  “specversion”: “1.0”,
  “type”: “retail.store.Store.AreaCrowded.v1”,
  “source”: “/default/source.retail/12345”,
  “subject”: “376611”,
  “time”: “2024-07-01T12:35:51.345Z”,
  “datacontenttype”: “application/json”,
  “data”: {
    “storeId”: “10000”,
    “areaId”: “376611”,
    “areaName”: “Tills 1-10”
  }
}
```

“Serialized item observed” example—a serialized item (e.g., a shirt with an RFID tag) has been observed at a certain place in a facility (e.g., by an autonomous robot driving through a store):

```
Event:
{
  “id”: “ff3e4663-9c98-4507-a776-b02”,
  “specversion”: “1.0”,
  “type”: “retail.store.SerializedItem.Observed.v0”,
  “source”: “/default/source.retail/12345”,
  “subject”: “303431711C5B08C0000027”,
  “time”: “2024-01-16T10:36:52.897Z”,
  “datacontenttype”: “application/json”,
  “data”: {
    “storeId”: “10000”,
    “runId”: 67575409,
    “itemId”: {
      “epc”: “303431711C5B08C0000027”
    },
    “confidence”: 0.121,
    “indoorCoordinates”: {
      “x”: −1.23,
      “y”: 2.12
    }
  }
}
```

“Temperature measured” example—temperature within a fridge of a facility:

```
Event:
{
  “id”: “a00b7888-42d0-4e26-8579-4aea57250b35”,
  “specversion”: “1.0”,
  “type”: “retail.store.Temperature.Measured.v0”,
  “source”: “/default/source.retail/12345”,
  “subject”: “4711081”,
  “time”: “2024-08-01T12:26:51.362Z”,
  “datacontenttype”: “application/json”,
  “data”: {
      “storeId”: “10000”,
      “equipmentId”: “4711081”,
      “storageLocation”: “0001”,
      “temperature”: {
        “air”: “4.1”,
        “core”: “3.1”,
        “unit”: “CEL”
      },
      “merchandiseCategoryHierarchyNode”: “12837”,
      “articleHierarchyNode”: “FOOD.FISH”,
      “placement”: {
        “floor”: “1st”,
        “aisle”: 5,
        “shelf”: 2,
        “planogramPosition”: {
          “sequenceNumber”: 2,
          “level”: 4
        }
      }
    }
  }
```

It is again noted that, in the three examples above, the event message has a standard format of “ID,” “specversion,” “type,” “source,” “subject,” “time,” “datacontenttype,” and “data.” For each new incoming event, the event gateway component 302 may check this format to determine whether the event message conforms to a standard format or schema in order to validate the event.

In some examples, for an event type (e.g., a standard event type), the “data” section of the event message is standardized by the corresponding schema. In other words, a standardized payload is defined for the event type. For example, and as shown in the above examples, the stored metadata for the “out-of-shelf” event type defines how each “out-of-shelf” event must look like from a data or payload perspective in order to be valid, while the stored metadata for the “shelf restocked” event type defines how each “shelf restocked” event must look like from a data or payload perspective in order to be valid. In some examples, if the “data” section of an incoming event message does not conform to the standardization as defined by the corresponding schema (e.g., the payload does not follow the standardized format), the event message is rejected by the event gateway component 302. This standardized payload format can then be used across different tenants, sensor technologies, and facilities.

In some examples, the event gateway component 302 thus analyzes schema items that are specific to the event type as part of the validation procedure (e.g., schema items that may not apply to all event types). For example, for an event of type “serialized item observed,” the event gateway component 302 may check whether the payload includes coordinates in the format defined by the schema in the event metadata repository 306 for the specific event type, and reject the event message if it is found to lack conformity with the schema.

Various other event types may be supported by the event handling platform 132. Other non-limiting examples of event types include “product misplaced,” “scan avoided,” “map updated,” and “inventory count completed.”

As mentioned, the event handling platform 132 may be coupled to a plurality of different facilities (e.g., to multiple retail stores). The facility may be identified, for example, based on the facility identifier (e.g., “storeID”) in the event message, or based on a source data field that indicates where the event originated.

FIG. 7 is an interaction diagram 700 illustrating interactions between various components to validate, route, and store the details of an event, according to some examples. By way of example and not limitation, the following components of FIGS. 1-3 are shown in the interaction diagram 700: the sensor installation 216, the event gateway component 302, the event metadata repository 306, the event bus 304, the task management application 134, the event ingestion pipeline component 310, and the file-based storage 140.

At send operation 702, the sensor installation 216 sends an event message to the event handling platform 132. The sensor installation 216 may, for example, be a smart sensor installation provided by a vendor at the facility 118 (which may, for example, be a retail store).

While only a single event message is described in some examples herein, it will be appreciated that the event handling platform 132 may receive multiple event messages, from the same sensor installation 216 or from different installations (e.g., from different sensor solution providers at different retail facilities), and deal with each respective event message as described herein.

The event gateway component 302 receives the event message and, at request operation 704, requests the metadata for the event type of the event message from the event metadata repository 306. At get operation 706, the metadata is retrieved from the event metadata repository 306. In some examples, the metadata is cached to facilitate processing thereof.

The event gateway component 302 then performs validation at validation operation 708. The event message may be standardized both from a technical format perspective (e.g., the technical schema of the event message) and from a payload perspective (e.g., the contents of the data section of the event message). The event type of the event message is described in the metadata within the event metadata repository 306, and the event gateway component 302 checks to confirm that the event, as represented by the event message, conforms to the requirements defined within the event metadata repository 306.

For example, the “out-of-shelf” event type, as shown above, has a schema that specifies the required data fields, data types, and overall structure (e.g., order and format of data) for that event. The event gateway component 302 identifies that the event message relates to an “out-of-shelf” event type (e.g., based on the event type identifier, such as an event name) and validates the message against the schema. Specifically, in some examples, the event gateway component 302 checks whether the data section of the event message conforms to a definition provided by the schema in the event metadata repository 306. In simple terms, the event gateway component 302 checks whether the event looks like all events of that event type must look like in order to be valid and accepted, irrespective of its source (e.g., irrespective of which facility or tenant it originates from).

After validation, at forwarding operation 710, the event message is sent to the event bus 304. The event gateway component 302 may also transmit a confirmation message to the sensor installation 216 at confirmation operation 712 to confirm that the event message has been received and validated.

At send operation 714, the event bus 304 causes the event message to be sent to the task management application 134 for real-time consumption, as described above. The event bus 304 also sends the event message to the event ingestion pipeline component 310 at send operation 716. In some examples, the event message, as received from the sensor installation 216, may be modified before it is delivered to the task management application 134 or the event ingestion pipeline component 310. For example, the event message may be reformatted, or additional information (such as metadata from the event metadata repository 306) may be added to the payload.

The task management application 134 may trigger an event reaction based on the event message. For example, when an automated shelf sensor (e.g., IoT shelf monitoring sensor) detects a product is out of stock, the task management application 134 automatically creates a restocking task, and automatically checks inventory and upcoming deliveries to ensure restocking is needed before creating the task.

As mentioned, the event handling platform 132 allows applications (e.g., applications provided by the server system 104 or partner applications) to subscribe to events. For example, a partner of the facility 118 that operates digital signage may receive shelf out-of-stock events and instantly update digital displays in the facility 118 to show the item at its secondary location. The partner may thus have a connected software application that listens for predetermined events and automatically pushes updated content to in-store displays.

The event ingestion pipeline component 310 may be configured to listen for validated events and ingest them after validation. In some examples, the event ingestion pipeline component 310 performs request operation 718 and get operation 720 to retrieve metadata from the event metadata repository 306. For example, the event ingestion pipeline component 310 may retrieve metadata relating to a received event for one or more of the following purposes: to obtain schema definitions, to determine how to transform event message data for persistence (e.g., determine a target data format for the event type), to check for storage rules (e.g., storage location or duration), or to determine a mapping between event fields (e.g., JSON fields) and storage columns (e.g., Parquet™ columns). The event ingestion pipeline component 310 may thus check a latest version of the schema in the event metadata repository 306 prior to causing storage of the event message data.

The event ingestion pipeline component 310 may also perform a validation operation 722 to validate that the event message includes, for example, the required fields for storage or data transformation. At transformation operation 724, the event ingestion pipeline component 310 transforms the event message into a format suitable for storage in the file-based storage 140 (e.g., in a format that can be stored for quick retrieval from a file-based data lake). At persist operation 726, the event ingestion pipeline component 310 stores the data relating to the event (e.g., the event history 312 of FIG. 3) in the file-based storage 140.

As mentioned, the data in the file-based storage 140 may be analyzed to gain useful insights. For example, shopping patterns detected via sensors (e.g., in-store IoT sensors) of a smart retail facility may be matched with transaction data to gain insights. This may allow a facility operator or owner to understand products that were examined in a store, but not purchased.

The interactions described in the interaction diagram 700 may, in some examples, allow for data from diverse or disparate IoT sensors to be unified and standardized to reduce integration costs. The event handling platform 132 may provide centralized ingestion and management. This may, for instance, make it significantly easier for a retail facility to switch from one technology vendor to another, as the new technology vendor may simply apply the already standardized event schemas.

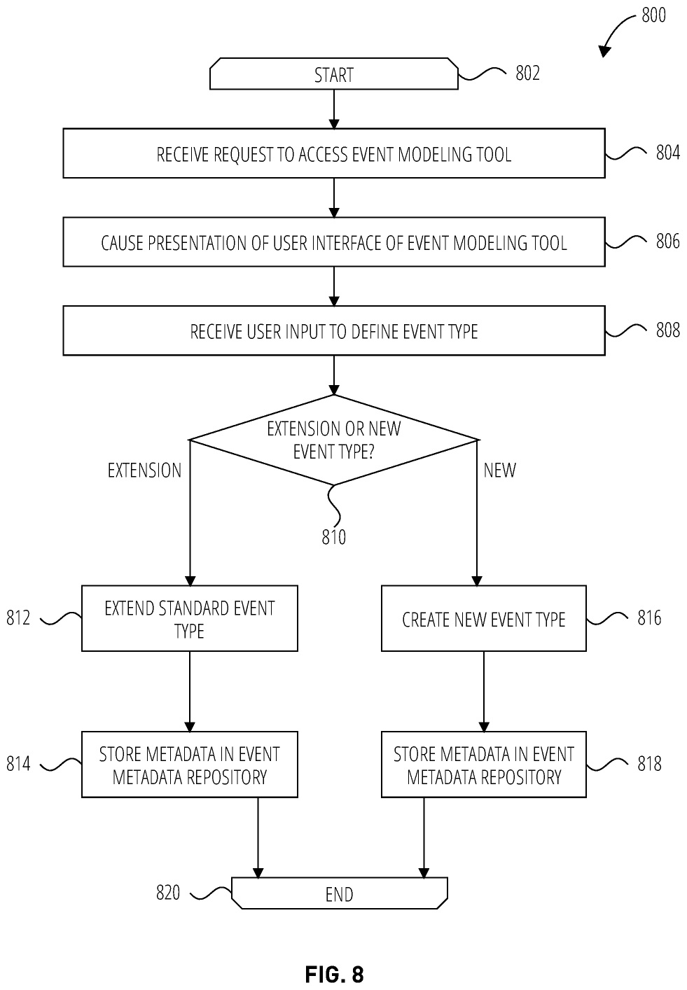

FIG. 8 is a flowchart illustrating operations of a method 800 suitable for providing an event modeling tool and allowing a user to create an event type, according to some examples. In the method 800, the event modeling tool is the event modeling tool component 308 of the event handling platform 132 of FIG. 3. However, it will be appreciated that the event modeling tool component 308 of FIG. 3 is referenced merely as a non-limiting example.

As mentioned, the event modeling tool component 308 provides the user interface 320 for defining new event types or extending existing event type definitions. The user interface 320 may, for example, be accessed via the user device 106 of FIG. 1. Furthermore, the event modeling tool component 308 may be used to adjust existing metadata for event types (e.g., to allow for new versions and version management).

The method 800 commences at opening loop element 802, and proceeds to operation 804 where the event modeling tool component 308 receives a request (e.g., from the user 108 via the user device 106) to access the event modeling tool. The request may identify a tenant. In response to the request, at operation 806, the event modeling tool component 308 causes presentation of the user interface 320. This allows a user associated with the tenant (e.g., having a user account linked to the tenant) to view, add, or extend event types.

At operation 808, the event modeling tool component 308 receives user input to define an event type. At decision operation 810, the event modeling tool component 308 checks whether the user input indicates that a standard event type is to be extended or added to, or whether the user input indicates that a (completely) new event type is to be created.

If a standard event type is to be extended, at operation 812, the event modeling tool component 308 changes or extends the metadata of the relevant standard event type as needed and causes the extended event type to be stored in the event metadata repository 306 (operation 814). This may result in an extended version of the schema of the standard event type being stored as part of a different, user-defined event type. The event modeling tool component 308 may be configured to ensure that the metadata for user-defined types are also stored in a standardized format.

For example, the user may take a standard event type that relates to a basic “temperature measured” event, and extend the event type to add customer-specific event properties. The user may thus build upon the standard event type to create a user-defined event type. In some examples, the user-defined event type is only accessible to users associated with the tenant that created the user-defined event type.

If a new event type is to be created without building upon a standard event type, the event modeling tool component 308 obtains metadata from the user input of the user and then creates the new event type at operation 816. The event modeling tool component 308 may use the user input to define a schema for the event type, as well as other metadata (e.g., storage rules or version), and causes the metadata to be stored in the event metadata repository 306 at operation 818. Again, the event modeling tool component 308 may ensure that the metadata is stored in a standardized format. The method 800 concludes at closing loop element 820.

In some examples, an event-driven architecture may thus be combined with model-driven design features to provide pre-standardized events and data models (e.g., tailored for retail use cases). This may enable relatively easy development and rapid implementation.

In some examples, event types (e.g., standard event types) may be created to support common use cases, such as inventory and task management, in a vendor-agnostic and technology-agnostic manner. This allows the platform to abstract the underlying sensor data such that applications may integrate with platform events rather than individual sensor APIs and formats.

FIG. 9 shows a diagram 900 that illustrates different event types in the event metadata repository 306 of FIG. 3. The event types are accessible via a first tenant 902 and a second tenant 904, according to some examples.

In the example of FIG. 9, an event handling platform (e.g., the event handling platform 132 of FIG. 1) is communicatively coupled to a plurality of different facilities (e.g., retail facilities). A first subset of facilities 906, 908, 910 is associated with the first tenant 902 using the event handling platform and a second subset of facilities 912, 914, 916 is associated with the second tenant 904 also using the event handling platform.

The first tenant 902 is associated with an operator of the facilities 906, 908, 910 that has smart sensors installed in the facilities 906, 908, 910 to report event messages to the event handling platform. The second tenant 904 is associated with an operator of the facilities 912, 914, 916 that has smart sensors installed in the facilities 912, 914, 916 to report event messages to the event handling platform. For example, the first tenant 902 may be used by users associated with a first retail store chain, while the second tenant 904 may be used by users associated with a second (unrelated) retail store chain.

The first tenant 902 and the second tenant 904 both have access to a plurality of standard event types 918. In this example, the standard event types 918 are predefined or generic event types that are available to all users or tenants (e.g., an “out-of-shelf” event type and a “temperature measured” event type). For example, both the first tenant 902 and the second tenant 904 can configure the in-store sensor systems of their sensor installations to publish events according to predetermined schemas defined by the standard event types 918. These events will then be validated and routed to the appropriate destinations by the event handling platform, as described elsewhere herein. Specifically, in some examples, the data sections or payload sections of event messages of these event types are required to conform to respective standardized schemas in order to be accepted and routed.

However, the first tenant 902 and the second tenant 904 have each also created their own user-defined event types in the form of user-defined event types 920 and user-defined event types 922, respectively. The user-defined event types 920 are only accessible to and usable by the first tenant 902, while the user-defined event types 922 are only accessible to and usable by the second tenant 904.

For example, the user-defined event types 920 may include a custom “foot traffic spike” event type that the first tenant 902 has specifically defined (e.g., using the event modeling tool) to detect and respond to certain foot traffic spikes in the facilities 906, 908, 910. The sensor installations of the first tenant 902 are configured to report or publish event messages according to the schema defined for the “foot traffic spike” event type in the event metadata repository 306. A cloud-based application of the first tenant 902 may be connected to the event handling platform to automatically trigger a suitable event reaction after a “foot traffic spike” event has been received (as an event message) and validated.

As another example, the user-defined event types 922 may include a custom “photo printer ink low” event type that the second tenant 904 has specifically defined (e.g., using the event modeling tool) to detect and respond to a low ink level of a self-service photo printer that is important in the context of one or more of the facilities 912, 914, 916. The sensor installations of the second tenant 904 are configured to send event messages according to the schema defined for the “photo printer ink low” event type in the event metadata repository 306. A cloud-based application of the second tenant 904 may be connected to the event handling platform to automatically trigger a suitable event reaction after a “photo printer ink low” event has been received (as an event message) and validated.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: receiving, from an identified sensor installation from among one or more sensor installations, an event message indicative of an event detected by the identified sensor installation, the identified sensor installation being associated with a facility; validating the event against a schema of an identified event type from among a plurality of event types by comparing the event message to metadata of the identified event type, the metadata of the identified event type being contained in an event metadata repository; in response to the validating of the event, transmitting the event message to a software application associated with the facility to trigger an event reaction that is linked to the identified event type; and causing presentation, at a user device accessing the software application, of status data for the facility, the status data being based on the event reaction.

In Example 2, the subject matter of any of Example 1 includes, wherein the validating of the event comprises determining that the event message conforms to the schema of the identified event type as defined by the metadata.

In Example 3, the subject matter of any of Examples 1-2 includes, wherein the validating of the event comprises determining that the event message has a standardized payload conforming to the schema of the identified event type as defined by the metadata.

In Example 4, the subject matter of Example 3 includes, wherein the one or more sensor installations comprise a plurality of sensor installations, each sensor installation associated with a respective facility, the facilities including a first subset of facilities associated with a first tenant and a second subset of facilities associated with a second tenant, the plurality of event types including a plurality of standard event types for which respective metadata are contained in the event metadata repository, and the metadata of each standard event type defining a respective standardized payload for event messages of the standard event type.

In Example 5, the subject matter of any of Examples 1-4 includes, wherein the transmitting of the event message comprises routing, in a first routing operation by an event bus, the event message to the software application in real-time, the event bus further performing a second routing operation to route the event message to a storage component that is accessible via the software application.

In Example 6, the subject matter of any of Examples 1-5 includes, wherein the event metadata repository contains metadata of each of the plurality of event types, the metadata of each of the plurality of event types comprises an event type identifier for the event type, and the operations further comprising: identifying the identified event type by detecting the event type identifier of the identified event type in the event message; and identifying the facility by detecting a facility identifier of the facility in the event message.

In Example 7, the subject matter of any of Examples 1-6 includes, wherein the plurality of event types includes one or more standard event types and one or more user-defined event types.

In Example 8, the subject matter of any of Examples 1-7 includes, wherein the one or more sensor installations comprise a plurality of sensor installations, each sensor installation associated with a respective facility, the facilities including a first subset of facilities associated with a first tenant and a second subset of facilities associated with a second tenant, the identified sensor installation and the user device being associated with the first tenant.

In Example 9, the subject matter of Example 8 includes, wherein the plurality of event types includes a plurality of standard event types and a plurality of user-defined event types, the first tenant and the second tenant each having access to the plurality of standard event types, and the first tenant and the second tenant having access to different subsets of the plurality of user-defined event types.

In Example 10, the subject matter of Example 9 includes, wherein the plurality of user-defined event types were created using an event modeling tool, the operations further comprising: causing presentation of a user interface of the event modeling tool; receiving, via the user interface and from a user of the first tenant, user input to define an additional user-defined event type, the user input including metadata of the additional user-defined event type; and in response to receiving the user input, storing the metadata of the additional user-defined event type in the event metadata repository to be accessible to the first tenant and inaccessible to the second tenant.

In Example 11, the subject matter of Example 10 includes, wherein the user input identifies a standard event type from among the plurality of standard event types, the additional user-defined event type being an extended version of the standard event type.

In Example 12, the subject matter of any of Examples 1-11 includes, wherein the identified sensor installation comprises one or more sensors and a data collection system connected to the one or more sensors.

In Example 13, the subject matter of any of Examples 1-12 includes, wherein the event reaction comprises automatic adjustment of a workflow associated with the facility to reflect a task, and the status data includes the task.

In Example 14, the subject matter of any of Examples 1-13 includes, wherein the software application is a cloud-based application that subscribes to events of the identified event type.

Example 15 is a method comprising: receiving, from an identified sensor installation from among one or more sensor installations, an event message indicative of an event detected by the identified sensor installation, the identified sensor installation being associated with a facility; validating the event against a schema of an identified event type from among a plurality of event types by comparing the event message to metadata of the identified event type, the metadata of the identified event type being contained in an event metadata repository; in response to the validating of the event, transmitting the event message to a software application associated with the facility to trigger an event reaction that is linked to the identified event type; and causing presentation, at a user device accessing the software application, of status data for the facility, the status data being based on the event reaction.

In Example 16, the subject matter of Example 15 includes, wherein the validating of the event comprises determining that the event message conforms to the schema of the identified event type as defined by the metadata.

In Example 17, the subject matter of any of Examples 15-16 includes, wherein the validating of the event comprises determining that the event message has a standardized payload conforming to the schema of the identified event type as defined by the metadata.

Example 18 is a non-transitory computer-readable medium that stores instructions that, when executed by one or more processors, cause the one or more processors to perform operations comprising: receiving, from an identified sensor installation from among one or more sensor installations, an event message indicative of an event detected by the identified sensor installation, the identified sensor installation being associated with a facility; validating the event against a schema of an identified event type from among a plurality of event types by comparing the event message to metadata of the identified event type, the metadata of the identified event type being contained in an event metadata repository; in response to the validating of the event, transmitting the event message to a software application associated with the facility to trigger an event reaction that is linked to the identified event type; and causing presentation, at a user device accessing the software application, of status data for the facility, the status data being based on the event reaction.

In Example 19, the subject matter of Example 18 includes, wherein the validating of the event comprises determining that the event message conforms to the schema of the identified event type as defined by the metadata.

In Example 20, the subject matter of any of Examples 18-19 includes, wherein the validating of the event comprises determining that the event message has a standardized payload conforming to the schema of the identified event type as defined by the metadata.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

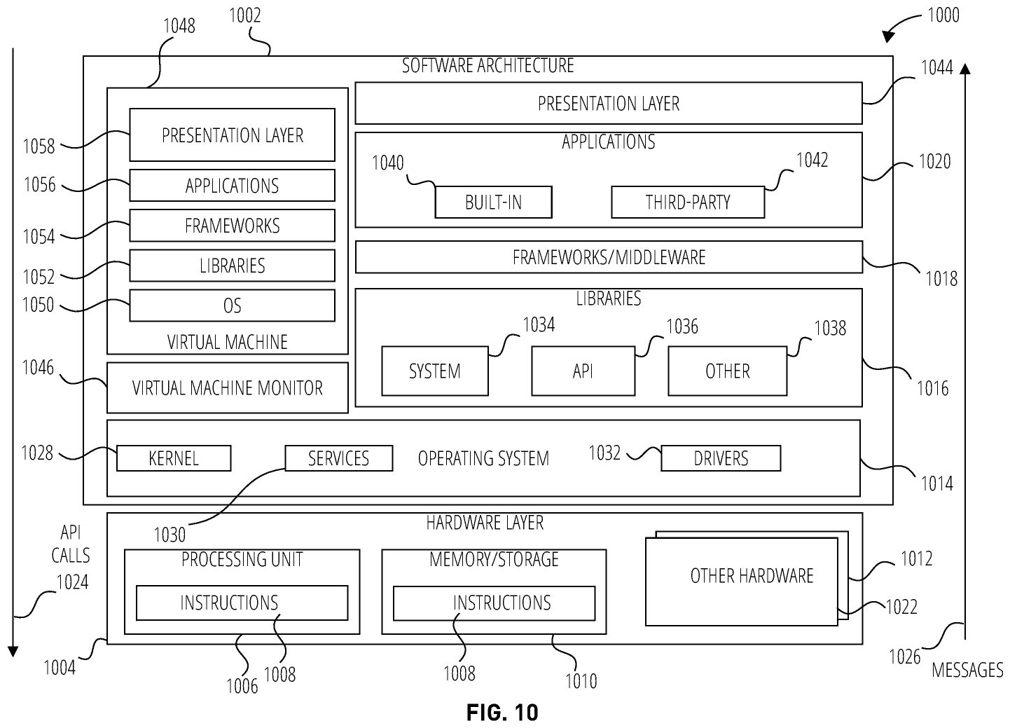

FIG. 10 is a block diagram 1000 showing a software architecture 1002 for a computing device, according to some examples. The software architecture 1002 may be used in conjunction with various hardware architectures, for example, as described herein. FIG. 10 is merely a non-limiting illustration of a software architecture, and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 11.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 and other hardware 1022 which represent any other hardware of the hardware layer 1004, such as the other hardware illustrated as part of the software architecture 1002.

In the architecture of FIG. 10, the software architecture 1002 may be conceptualized as a stack of layers where each layer provides particular functionality. For example, the software architecture 1002 may include layers such as an operating system 1014, libraries 1016, frameworks/middleware layer 1018, applications 1020, and presentation layer 1044. Operationally, the applications 1020 or other components within the layers may invoke API calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the software architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1016 may provide a common infrastructure that may be utilized by the applications 1020 or other components or layers. The libraries 1016 typically provide functionality that allows other software modules to perform tasks in an easier fashion than to interface directly with the underlying operating system 1014 functionality (e.g., kernel 1028, services 1030 or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware layer 1018 may provide a higher-level common infrastructure that may be utilized by the applications 1020 or other software components/modules. For example, the frameworks/middleware layer 1018 may provide various graphic user interface (GUI) functions, high-level resource management, high-level location services, and so forth. The frameworks/middleware layer 1018 may provide a broad spectrum of other APIs that may be utilized by the applications 1020 or other software components/modules, some of which may be specific to a particular operating system or platform.

The applications 1020 include built-in applications 1040 or third-party applications 1042. Examples of representative built-in applications 1040 may include, but are not limited to, a contacts application, a browser application, a book reader application, a location application, a media application, a messaging application, or a game application. Third-party applications 1042 may include any of the built-in applications as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built in operating system functions (e.g., kernel 1028, services 1030 or drivers 1032), libraries (e.g., system libraries 1034, API libraries 1036, and other libraries 1038), and frameworks/middleware layer 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine as well as the interface with the host operating system (e.g., operating system 1014). A software architecture executes within the virtual machine 1048 such as an operating system 1050, libraries 1052, frameworks/middleware 1054, applications 1056 or presentation layer 1058. These layers of software architecture executing within the virtual machine 1048 can be the same as corresponding layers previously described or may be different.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module that operates to perform certain operations as described herein.

In various examples, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules are temporarily configured (e.g., programmed), each of the hardware-implemented modules need not be configured or instantiated at any one instance in time. For example, where the hardware-implemented modules comprise, a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some examples, the processor or processors may be located in a single location (e.g., within a home environment, an office environment, or a server farm), while in other examples the processors may be distributed across a number of locations.

The one or more processors may also operate to support performance of the relevant operations in a “cloud computing” environment or as a “software as a service (Saas).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In examples, operations may be performed by one or more programmable processors executing a computer program to perform functions by operating on input data and generating output. Method operations can also be performed by, and apparatus of some examples may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various examples.

FIG. 11 is a block diagram of a machine in the example form of a computer system 1100 within which instructions 1124 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a GPU, or both), a primary or main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a UI navigation (or cursor control) device 1114 (e.g., a mouse), a storage unit 1116, a signal generation device 1118 (e.g., a speaker), and a network interface device 1120.

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 or within the processor 1102 during execution thereof by the computer system 1100, with the main memory 1104 and the processor 1102 also each constituting a machine-readable medium 1122.

While the machine-readable medium 1122 is shown in accordance with some examples to be a single medium, the term “machine-readable medium” may include a single medium or multiple media (e.g., a centralized or distributed database, or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with such instructions 1124. The term “machine-readable medium” shall accordingly be taken to include, but not be limited to, solid-state memories, and optical and magnetic media. Specific examples of a machine-readable medium 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 1124 may further be transmitted or received over a communications network 1126 using a transmission medium. The instructions 1124 may be transmitted using the network interface device 1120 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the inventive subject matter may be referred to herein, individually or collectively, by the “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
receiving, from an identified sensor installation from among one or more sensor installations, an event message indicative of an event detected by the identified sensor installation, the identified sensor installation being associated with a facility;
validating the event against a schema of an identified event type from among a plurality of event types by comparing the event message to metadata of the identified event type, the metadata of the identified event type being contained in an event metadata repository;
in response to the validating of the event, transmitting the event message to a software application associated with the facility to trigger an event reaction that is linked to the identified event type; and
causing presentation, at a user device accessing the software application, of status data for the facility, the status data being based on the event reaction.

2. The system of claim 1, wherein the validating of the event comprises determining that the event message conforms to the schema of the identified event type as defined by the metadata.

3. The system of claim 1, wherein the validating of the event comprises determining that the event message has a standardized payload conforming to the schema of the identified event type as defined by the metadata.

4. The system of claim 3, wherein the one or more sensor installations comprise a plurality of sensor installations, each sensor installation associated with a respective facility, the facilities including a first subset of facilities associated with a first tenant and a second subset of facilities associated with a second tenant, the plurality of event types including a plurality of standard event types for which respective metadata are contained in the event metadata repository, and the metadata of each standard event type defining a respective standardized payload for event messages of the standard event type.

5. The system of claim 1, wherein the transmitting of the event message comprises routing, in a first routing operation by an event bus, the event message to the software application in real-time, the event bus further performing a second routing operation to route the event message to a storage component that is accessible via the software application.

6. The system of claim 1, wherein the event metadata repository contains metadata of each of the plurality of event types, the metadata of each of the plurality of event types comprises an event type identifier for the event type, and the operations further comprising:
identifying the identified event type by detecting the event type identifier of the identified event type in the event message; and
identifying the facility by detecting a facility identifier of the facility in the event message.

7. The system of claim 1, wherein the plurality of event types includes one or more standard event types and one or more user-defined event types.

8. The system of claim 1, wherein the one or more sensor installations comprise a plurality of sensor installations, each sensor installation associated with a respective facility, the facilities including a first subset of facilities associated with a first tenant and a second subset of facilities associated with a second tenant, the identified sensor installation and the user device being associated with the first tenant.

9. The system of claim 8, wherein the plurality of event types includes a plurality of standard event types and a plurality of user-defined event types, the first tenant and the second tenant each having access to the plurality of standard event types, and the first tenant and the second tenant having access to different subsets of the plurality of user-defined event types.

10. The system of claim 9, wherein the plurality of user-defined event types were created using an event modeling tool, the operations further comprising:
causing presentation of a user interface of the event modeling tool;
receiving, via the user interface and from a user of the first tenant, user input to define an additional user-defined event type, the user input including metadata of the additional user-defined event type; and
in response to receiving the user input, storing the metadata of the additional user-defined event type in the event metadata repository to be accessible to the first tenant and inaccessible to the second tenant.

11. The system of claim 10, wherein the user input identifies a standard event type from among the plurality of standard event types, the additional user-defined event type being an extended version of the standard event type.

12. The system of claim 1, wherein the identified sensor installation comprises one or more sensors and a data collection system connected to the one or more sensors.

13. The system of claim 1, wherein the event reaction comprises automatic adjustment of a workflow associated with the facility to reflect a task, and the status data includes the task.

14. The system of claim 1, wherein the software application is a cloud-based application that subscribes to events of the identified event type.

15. A method comprising:
receiving, from an identified sensor installation from among one or more sensor installations, an event message indicative of an event detected by the identified sensor installation, the identified sensor installation being associated with a facility;
validating the event against a schema of an identified event type from among a plurality of event types by comparing the event message to metadata of the identified event type, the metadata of the identified event type being contained in an event metadata repository;
in response to the validating of the event, transmitting the event message to a software application associated with the facility to trigger an event reaction that is linked to the identified event type; and
causing presentation, at a user device accessing the software application, of status data for the facility, the status data being based on the event reaction.

16. The method of claim 15, wherein the validating of the event comprises determining that the event message conforms to the schema of the identified event type as defined by the metadata.

17. The method of claim 15, wherein the validating of the event comprises determining that the event message has a standardized payload conforming to the schema of the identified event type as defined by the metadata.

18. A non-transitory computer-readable medium that stores instructions that, when executed by one or more processors, cause the one or more processors to perform operations comprising:
receiving, from an identified sensor installation from among one or more sensor installations, an event message indicative of an event detected by the identified sensor installation, the identified sensor installation being associated with a facility;
validating the event against a schema of an identified event type from among a plurality of event types by comparing the event message to metadata of the identified event type, the metadata of the identified event type being contained in an event metadata repository;
in response to the validating of the event, transmitting the event message to a software application associated with the facility to trigger an event reaction that is linked to the identified event type; and
causing presentation, at a user device accessing the software application, of status data for the facility, the status data being based on the event reaction.

19. The non-transitory computer-readable medium of claim 18, wherein the validating of the event comprises determining that the event message conforms to the schema of the identified event type as defined by the metadata.

20. The non-transitory computer-readable medium of claim 18, wherein the validating of the event comprises determining that the event message has a standardized payload conforming to the schema of the identified event type as defined by the metadata.
